(19) United States
(12) Patent Application Publication
(10) Pub. No.: US 2005/0126233 A1
(43) Pub. Date: Jun. 16, 2005

(54) Hanging lock structure

(76) Inventor: Chun-Te Yu, Fu-Hsing Hsiang (TW)

Correspondence Address: BRUCE H. TROXELL, SUITE 1404, 5205 LEESBURG PIKE, FALLS CHURCH, VA, 22041, US

(21) Appl. No.: 11/044,074

(22) Filed: Jan. 28, 2005

Related U.S. Application Data
(62) Division of application No. 10/676,853, filed on Sep. 30, 2003, now Pat. No. 6,860,125.

(51) Int. Cl. E05B 37/02

(52) U.S. Cl. 70/25

(57) ABSTRACT

A hanging lock structure including: a lock main body in which a lock core is arranged, the lock core serving to control locking/unlocking of the hanging lock; a lock hook having a base end and an extending free end, the base end being pivotally inserted in one end of the lock main body, whereby the free end of the lock hook can be horizontally rotated about the axis of the base end; and a displaceable button disposed on the lock main body for restricting the free end of the lock hook. Top end of the displaceable button is formed with a notch in which the free end of the lock hook is restricted in a locked state. When the lock core is locked, the displaceable button is synchronously restricted from displacing to keep locking the lock hook. When the lock core is unlocked, the displaceable button is synchronously displaceable, permitting the free end of the lock hook to be turned out of the notch for unlocking. The hanging lock has firmer lock hook and can be operated with single hand.

This application is a divisional of U.S. Ser. No. 10/676,853, entitled “Numeral Lock Structure” filed on Sep. 30, 2003 and currently pending.

### BACKGROUND OF THE INVENTION

The present invention is related to an improved hanging lock structure, and more particularly to a hanging lock having simple structure and can be conveniently operated.

In a conventional hanging lock, a lock core is disposed in a lock body. The lock core is connected with an outward extending U-shaped lock hook. A free end of the lock hook can be inserted and locked in the lock hole formed on the lock body. Multiple numeral wheels are fitted around the lock core. The lock core can be unlocked/locked with a key or by means of the numeral wheels. The numerals on the surfaces of the numeral wheels are exposed to outer side of the lock body. In use, the numeral wheels are turned to preset unlocking number to unlock the lock core. Then the lock hook is tracked outward to extract the free end of the lock hook from the lock hole. Such structure has some shortcomings as follows:
1. After the lock core is unlocked with the key or by means of the numeral wheels, a user needs to hold the lock body with one hand and pull the lock hook with the other hand to extract the free end of the lock hook from the lock hole of the lock body. Therefore, the unlocking operation needs both hands to accomplish. This is inconvenient.
2. The lock hook is directly connected with the lock core which is restricted by the numeral wheels. Accordingly, a thief can continuously pull the lock hook and at the same time turn the respective numeral wheels. When the numeral wheels are positioned in the unlocking position (number), the lock core will loosen so that an unauthorized person can unlock the lock.
3. The lock hook and the lock core are synchronously driven.

The sections of the numeral wheels engaged with the lock core have limited structural strength. Therefore, a thief can easily knock out the lock hook to damage the lock core. Accordingly, such lock structure has poor burglarproof effect.

### SUMMARY OF THE INVENTION

It is therefore a primary object of the present invention to provide a hanging lock structure including: a lock main body in which a lock core is arranged, the lock core being controlled by a key or multiple numeral wheels to lock or unlock the hanging lock; a lock hook having a base end and an extending free end, the base end being pivotally inserted in one end of the lock main body, whereby the free end of the lock hook can be freely rotated about the axis of the base end; and a displaceable button disposed on the lock main body and controllable by the lock core to restrict the movement of the lock hook. Topside of the displaceable button is formed with a notch in which the free end of the lock hook is restricted in a locked state. When the lock core is locked, the displaceable button is synchronously restricted from displacing to keep locking the lock hook. When the lock core is unlocked, the displaceable button is synchronously displaceable, permitting the free end of the lock hook to be turned outward and detach out from the notch for unlocking. When the lock core is unlocked with the key or by means of the numeral wheels, a user can hold the lock main body and at the same time rotate the displaceable button to open the lock hook with single hand. This is convenient to the user.

It is a further object of the present invention to provide the above numeral lock structure in which the displaceable button is substantially a rotary roller. One end of the displaceable button is formed with a notch tapered from one side to the center. A shaft section projects from the other end of the displaceable button into the lock main body. An extending section is formed at bottom end of the displaceable button. The extending section is inserted into the main body to be controlled by the lock core. When the lock core is unlocked, the displaceable button is released and can be laterally rotated. After the notch of the displaceable button is turned to a direction to free the free end of the lock hook, the free end of the lock hook can be rotated to an unlocking position and detached out of the notch of the displaceable button for unlocking.

It is still a further object of the present invention to provide the above numeral lock structure in which the lock core and the lock hook are separate members without drivingly connecting with each other. Therefore, a thief cannot damage the lock core to unlock the hanging lock. Therefore, a better burglarproof effect is achieved.

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a perspective assembled view of the first embodiment of the present invention;

FIG. 3 is a sectional view of the first embodiment of the present invention in a locked state;

FIG. 3A is a top view according to FIG. 3;

FIG. 4 is a sectional view of the first embodiment of the present invention in an unlocked state;

FIG. 4A is a top view according to FIG. 4;

FIG. 5 is a sectional view of the second embodiment of the present invention in an unlocked state; and

FIG. 5A is a top view according to FIG. 5.

### DETAILED DESCRIPTION OF THE PREFERRED EMBODIMENTS

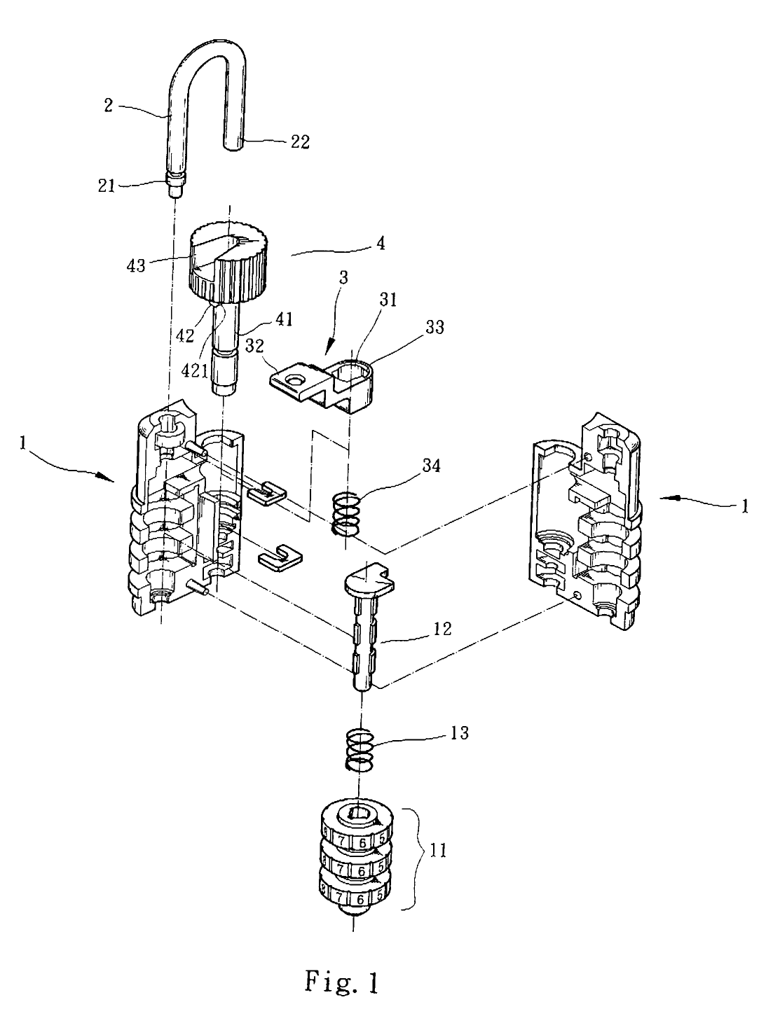

Please refer to FIG. 1 which shows a first embodiment of the present invention. The hanging lock includes a lock main body 1, a lock hook 2, a linking member 3 and a rotary displaceable button 4. A lock core 12 is arranged in the lock main body 1. Multiple numeral wheels 11 are fitted on the lock core 12. When the numeral wheels 11 are turned to the correct number, the lock core 12 can be unlocked and moved. Alternatively, the lock core 12 can be directly unlocked with a key. A resilient member 13 such as a spring is fitted on the lock core 12. The resilient member 13 is compressed between the top end of the lock core 12 and the numeral wheels 11, whereby in normal state, the lock core 12 is resiliently forced to abut against the linking member 3. The lock hook 2 is substantially U-shaped and has a base end 21 and an extending free end 22. The base end 21 is pivotally inserted in one end of the lock main body 1, whereby the lock hook 2 can be freely laterally rotated about the axis of the base end 21. The linking member 3 is formed with a central through shaft hole 31. The circumference of top side of the shaft hole 31 is formed with a recessed section 33. Two sides of the recessed section 33 are respectively formed with two lateral recessed slopes 331 which upward obliquely extend. In addition, a plane plate-like pressing section 32 extends from a lateral edge of the linking member 3 toward the lock core 12.

The top end of the rotary displaceable button 4 is substantially a roller. The roller is formed with a notch 43 tapered from one side to the center. A shaft section 41 projects from lower end of the roller. An acute projecting section 42 corresponding to the recessed section 33 is formed at an adjoining section between the shaft section 41 and the roller. Two sides of the acute projecting section 42 are formed with lateral projecting slopes 421 corresponding to the lateral recessed slopes 331.

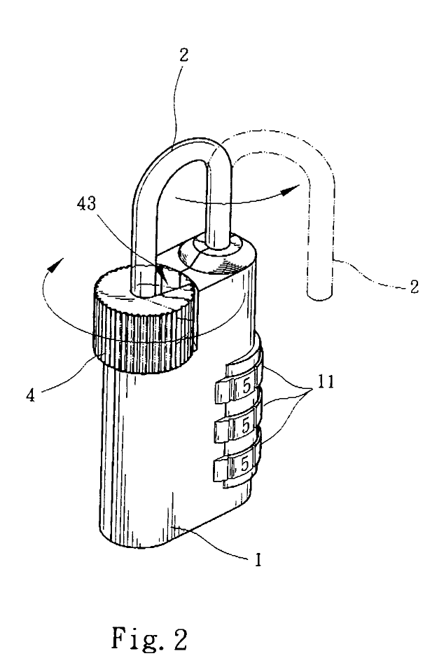

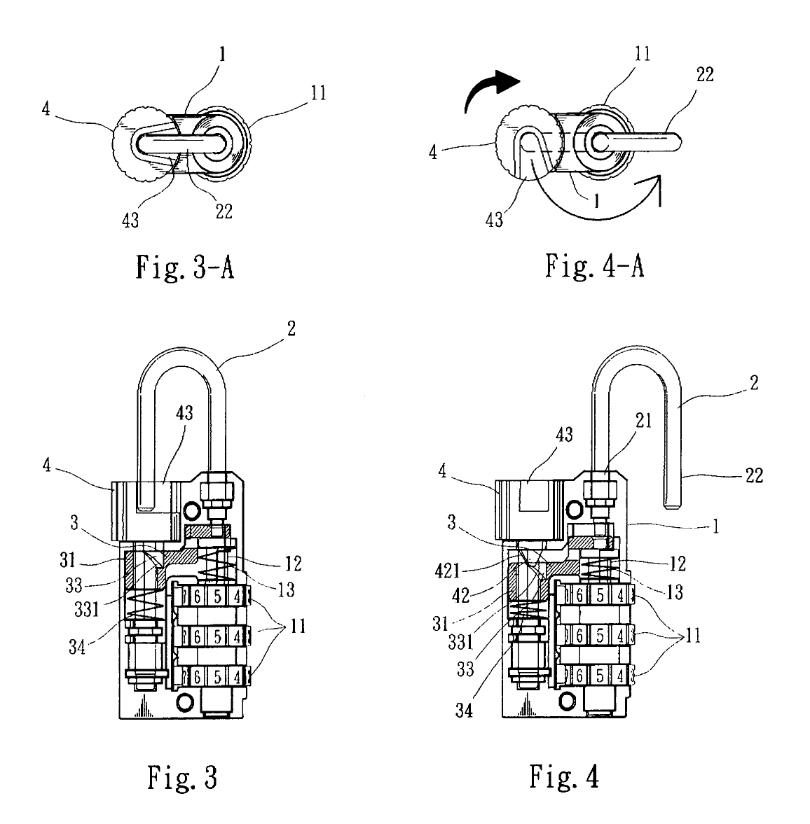

FIG. 2 is a perspective assembled view according to FIG. 1. Also with reference to FIG. 3, when assembled, the linking member 3 and the lock core 12 are disposed in the lock main body 1 on different sides thereof. The pressing section 32 of the linking member 3 extends to upper side of the lock core 12 to press the same. The shaft section 41 of the displaceable button 4 is inserted into the lock main body 1 and rotatably passed through the shaft hole 31 of the linking member 3. A resilient member 34 such as a spring is disposed between the linking member 3 and the inner side of the lock main body 1 near the tail end of the shaft section 41. The resilient member 34 makes the linking member 3 naturally attach to the end of the lock main body in which the displaceable button 4 is inserted. The acute projecting section 42 of the displaceable button 4 is totally inlaid in the recessed section 33 of the linking member 3. The notch 43 of top side of the displaceable button 4 is kept in a closed position to restrict the movement of the free end 22 of the lock hook 2. Accordingly, when the numeral wheels 11 are in the locking position (incorrect unlocking number), the lock core 12 is engaged and cannot be pressed down. At this time, the lock core 12 abuts against the linking member 3 to prevent the linking member 3 from descending. Therefore, the displaceable button 4 is restricted from moving, that is, the displaceable button 4 cannot be turned so that the free end 22 of the lock hook 2 is still restricted by the displaceable button 4 from rotating out for unlocking.

FIG. 4 shows the unlocking operation of the first embodiment of the present invention. When the numeral wheels 11 are turned to the unlocking number, the lock core 12 is released from the engagement. At this time, the lock core 12 can be pressed down. When rotating the displaceable button 4, the acute projecting section 42 of the displaceable button 4 downward slides alone the lateral recessed slopes 331 of the recessed section 33 to press down the top side of the linking member 3. Accordingly, the bottom end of the linking member 3 compresses the resilient member 34 and moves downward. At the same time, the pressing section 32 downward presses the lock core 12 (and the resilient member 13). After the displaceable button 4 is rotated by about 90 degrees, the notch 43 of top side of the displaceable button 4 is turned to a direction to free the free end 22 of the lock hook 2, whereby the free end 22 of the lock hook 2 can be rotated to an unlocking position and detached out of the notch 43 of the displaceable button 4 (as shown by phantom line of FIG. 2 and FIG. 4A).

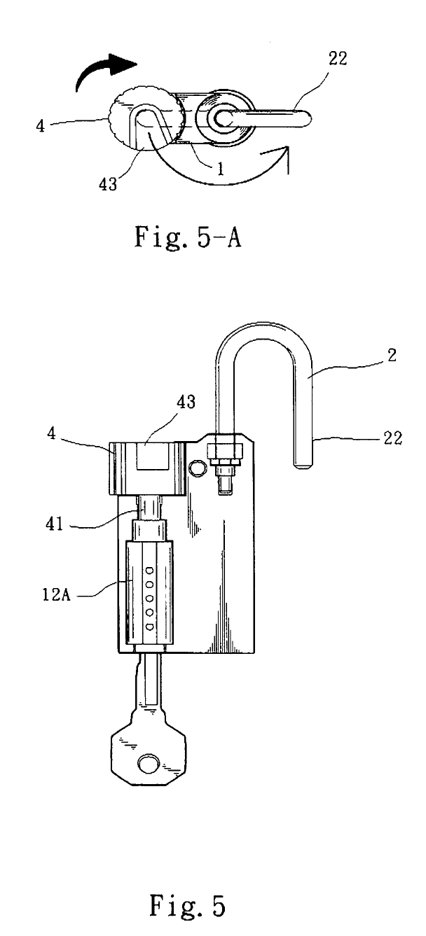

Alternatively, the linking member 3 can be removed. The lock core 12A is directly is directly disposed on the shaft section 41 of the displaceable button 4. A key 5 (as shown in FIG. 5) is directly inserted into the main body 1 to drive the lock core 12A. The shaft section 41 of the displaceable button 4 is driven by the lock core 12A to rotate the notch 3 so as to release the free end 22.

The above embodiments are only used to illustrate the present invention, not intended to limit the scope thereof. Many modifications of the above embodiments can be made without departing from the spirit of the present invention.

1. A hanging lock structure comprising:
a lock main body in which a lock core is arranged, the lock core serving to control locking/unlocking of the hanging lock;
a lock hook having a middle bent section and a base end and an extending free end, the base end being pivotally inserted in one end of the lock main body, whereby the lock hook can be laterally horizontally rotated about an axis of the base end relative to the lock main body; and
a displaceable button disposed on the lock main body in a position where the free end of the lock hook is turned in or out, whereby in accordance with the locked state or unlocked state of the lock core, the displaceable button is synchronously positioned in a not displaceable state or a displaceable state, the displaceable button being formed with a restricting section corresponding to the free end of the lock hook for restricting the same, whereby when the lock core is locked, the displaceable button is synchronously restricted from displacing to keep locking the free end of the lock hook and prevent the free end from being laterally horizontally rotated to unlock the hanging hook, while when the lock core is unlocked, the displaceable button is synchronously in a displaceable state and can be displaced, permitting the free end of the lock hook to be laterally horizontally turned out of the restricting section relative to the main body for unlocking the hanging lock.

2. The hanging lock structure as claimed in claim 1, wherein a linking member is connected between the displaceable button and the lock core for synchronously drivingly connecting the displaceable button and the lock core.

3. The hanging lock structure as claimed in claim 1, wherein the displaceable button is substantially a rotary roller, one end of the displaceable button being formed with a notch tapered from one side to the center, a shaft section projecting from the other end of the displaceable button into the lock main body, the shaft section being inserted in the lock main body and fitted through the shaft hole of the linking member, whereby the displaceable button is rotatable about the shaft section, an acute projecting section being formed at an adjoining section between the shaft section and the displaceable button, whereby when the displaceable button is rotated, the acute projecting section of the displaceable button slides into or out of the recessed section of the linking member and when the acute projecting section slides out of the recessed section, the acute projecting section gradually presses down the linking member for unlocking.

4. The hanging lock structure as claimed in claim 3, wherein two sides of the acute projecting section are formed with lateral projecting slopes which upward obliquely extend.

5. The hanging lock structure as claimed in claim 3, wherein a resilient member is disposed between the shaft section of the displaceable button and the linking member to resiliently abut against the linking member, whereby the acute projecting section of the displaceable button can be tightly fitted in the recessed section of the linking member.

6. The hanging lock structure as claimed in claim 2, wherein the displaceable button is substantially a rotary roller, one end of the displaceable button being formed with a notch tapered from one side to the center, a shaft section projecting from the other end of the displaceable button into the lock main body, the shaft section being inserted in the lock main body and fitted through the shaft hole of the linking member, whereby the displaceable button is rotatable about the shaft section, an acute projecting section being formed at an adjoining section between the shaft section and the displaceable button, whereby when the displaceable button is rotated, the acute projecting section of the displaceable button slides into or out of the recessed section of the linking member and when the acute projecting section slides out of the recessed section, the acute projecting section gradually presses down the linking member for unlocking.
